(19) United States
(12) Patent Application Publication
(10) Pub. No.: US 2005/0272610 A1
(43) Pub. Date: Dec. 8, 2005

(54) Apparatus and methods of tissue ablation using Sr vapor laser system

(75) Inventors: Borislav Lubomirov Ivanov, Nashville, TN (US); Richard F. Haglund JR., Brentwood, TN (US); E. Duco Jansen, Nashville, TN (US); Ivan Kostadinov, Sofia (BG); David Piston, Nashville, TN (US); Anatoli N. Soldatov, Tomsk (RU)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Vanderbilt University, Nashville, TN (US)

(21) Appl. No.: 11/136,073

(22) Filed: May 24, 2005

Related U.S. Application Data
(60) Provisional application No. 60/573,907, filed on May 24, 2004.

(51) Int. Cl. B23K 1/00

(52) U.S. Cl. 505/474

(57) ABSTRACT

An apparatus for ablating living tissue. In one embodiment, the apparatus includes a first Sr vapor laser for generating a first laser beam, a second Sr vapor laser for receiving and amplifying the first laser beam, and a spatial filter optically positioned between and coupled to the first Sr vapor laser and the second Sr vapor laser for allowing selected fractions of the first laser beam to be received and amplified by the second Sr vapor laser so as to generate a second laser beam with sufficient strength and beam quality in a single pulse for ablating living tissue.

### CROSS-REFERENCE TO RELATED PATENT APPLICATION

This application claims the benefit, pursuant to 35 U.S.C. §119(e), of provisional U.S. patent application Ser. No. 60/573,907, filed May 24, 2004, entitled “APPARATUS AND METHODS OF TISSUE ABLATION USING Sr VAPOR LASER,” by Borislav Lubomirov Ivanov, Richard F. Haglund, Jr., E. Duco Jansen, Ivan Kostadinov, David Piston, and Anatoli N. Soldatov, which is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference. In terms of notation, hereinafter, “[n]” represents the nth reference cited in the reference list. For example, [9] represents the 9th reference cited in the reference list, namely, G. S. Edwards, R. H. Austin, F. E. Carroll, M. L. Copeland, M. E. Couprie, W. E. Gabella, R. F. Haglund, B. A. Hooper, M. S. Hutson, E. D. Jansen, et al., “Free electron laser based biophyscal and biomedical instrumentation,” Review of Scientific Instrumentation, vol. 74, pp. 3207-3245, 2003.

### STATEMENT OF FEDERALLY-SPONSORED RESEARCH

The present invention was made with Government support under a contract F49620-01-0429 awarded by Department of Defense Medical Free-Electron Laser Program. The United States Government may have certain rights to this invention pursuant to these grants.

### FIELD OF THE INVENTION

The present invention generally relates to ablation of living tissue, and in particular to the utilization of a strontium vapor laser system to generate a laser beam with sufficient strength and beam quality in a single pulse for ablating living tissue.

### BACKGROUND OF THE INVENTION

Laser technology is currently used in clinical medical practice in a variety of applications, including as a surgical tool for the therapeutic ablation of human tissues, both internal and external. In some applications, the precision obtainable by a narrowly and accurately focused beam of laser radiation is superior to other more traditional surgical techniques.

Laser radiation at 6.45 μm in wavelength generated by a tunable free electron laser (hereinafter “FEL”) has been shown to provide efficient soft tissue ablation with minimal collateral damage (<40 μm). This wavelength corresponds to Amide II of absorption bands of proteins. An United States patent with U.S. Pat. No. 5,403,306 to Edwards et al, which is incorporated herein in its entirety by reference, is understood to disclose a method for tissue ablation using a FEL tuned at one of three amide absorption bands including Amide II (6.45 μm). To date delivery of this wavelength of light with significant energy for ablation has been limited to a FEL, in particular, a Mark-III FEL. Furthermore, the FEL operates at a maximum frequency of 30 Hz, and thus operates like a traditional pulsed laser, where each pulse removes material and each subsequent pulse comes well after the stress and thermal relaxation times of tissue, thus acting like a new event (barring some residual heat left in the tissue). This may be characterized by significantly thermal superposition due to subsequent pulses, which leads to an increase in the thermal damage that occurs to the target tissue. Additionally, size, cost, and considerable overhead needed for operation of such a device preclude it from becoming a viable clinical delivery system [1-9].

Several 6.45 μm sources including an Er:YAG pumped optical parametric oscillator (hereinafter “OPO”) laser have been evaluated for ablating living tissue. Unfortunately, the surgical performance of the laser sources was unacceptable. The failures highlight a key point: the surgical performance of a laser system is not determined by wavelength alone, but by a combination of wavelength, intensity and pulse structure. Additionally, the Er:YAG pumped OPO laser suffers from limitation of low repetition rate, and works too close to the damage threshold fluence of the nonlinear crystal.

Realization of a scalable and cost effective laser source for delivering laser radiation at wavelength 6.45 μm with quality, intensity, and average power levels capable of tissue ablation in a single laser pulse with minimal thermal damages to surrounding tissue would have a much greater clinical relevance.

Therefore, a heretofore unaddressed need exists in the art to address the aforementioned deficiencies and inadequacies.

### SUMMARY OF THE INVENTION

The present invention, in one aspect, relates to an apparatus for ablating living tissue, where the apparatus is adapted for tabletop operations. In one embodiment, the apparatus includes a first strontium (hereinafter “Sr”) vapor laser for generating a first laser beam, a second Sr vapor laser for receiving and amplifying the first laser beam, and a spatial filter optically positioned between and coupled to the first Sr vapor laser and the second Sr vapor laser for allowing selected fractions of the first laser beam to be received and amplified by the second Sr vapor laser so as to generate a second laser beam with sufficient strength in a single pulse for ablating living tissue. In one embodiment, each of the first Sr vapor laser and the second Sr vapor laser operates with a repetition rate in the range of from 1 kHz to 20 kHz and substantially around a wavelength of 6.45 μm that approximately corresponds to an energy absorption peak of at least one amide band of said living tissue. The first Sr vapor laser and the second Sr vapor laser have same or different optical parameters. In one embodiment, the second laser beam generated has a maximum intensity higher than the maximum intensity of the laser beam generated by either the first Sr vapor laser or the second Sr vapor laser individually.

The apparatus further includes an unstable resonator system to operate with the first Sr vapor laser to maximize the output of the first Sr vapor laser. In one embodiment, the unstable resonator system comprises a first mirror, a second mirror, and a third mirror optically positioned between the first mirror and the second mirror along an optical path. The first mirror includes a concave mirror having a focal length, the second mirror has a concave mirror having a focal length, and the third mirror includes a scraped mirror for outputting the first laser beam.

Furthermore, the apparatus includes an expanding telescope positioned along an optical path between the first Sr vapor laser and the second Sr vapor laser. In one embodiment, the expanding telescope comprises a first optical lens for receiving an incoming beam of light, a second complimentary optical lens for outputting an outgoing beam of light corresponding to the incoming beam of light, and a focal plane formed therebetween. In another embodiment, the expanding telescope comprises a first concave mirror having a focal length, which receives an incoming beam of light, and a second concave mirror having a focal length, which outputs an outgoing beam of light corresponding to the incoming beam of light, and a focal plane formed therebetween. In one embodiment, the spatial filter is adjustable to allow the expanding telescope to function to selectively expanding fractions of the incoming beam of light and outputting it as the outgoing beam of light.

Moreover, the apparatus includes a timing control device arranged, in use, to communicate with the first Sr vapor laser and the second Sr vapor laser to synchronize them such that the second laser beam generated has sufficient strength and beam quality in a single pulse for ablating living tissue. In one embodiment, the timing control device has a synchronization module having a first output and a second output, a first power supply with a high voltage output, and a second power supply with a high voltage output. The first power supply is electrically coupled to the first output of the synchronization module and to the first Sr vapor laser through the high voltage output. The second power supply is electrically coupled to the second output of the synchronization module and to the second Sr vapor laser through the high voltage output. In one embodiment, the timing control device controls the first Sr vapor laser and the second Sr vapor laser such that the second Sr vapor laser may function as an optical shutter to produce the second laser beam with an intensity that is above a threshold of intensity for single pulse ablation. The threshold of intensity for single pulse ablation, in one embodiment, is about 2 J/cm².

Additionally, the apparatus has means for focusing the second laser beam to a targeted region of a living subject for ablating living tissue.

In another aspect, the present invention relates to a method of ablating living tissue. In one embodiment, the method includes the step of providing an apparatus. The apparatus has a first Sr vapor laser for generating a first laser beam, a second Sr vapor laser for receiving and amplifying the first laser beam, and a spatial filter optically positioned between and coupled to the first Sr vapor laser and the second Sr vapor laser for allowing selected fractions of the first laser beam to be received and amplified by the second Sr vapor laser.

The method further includes the steps of operating the apparatus to output a second laser beam from the second Sr vapor laser, directing the second laser beam to a targeted region of a living subject at living tissue to be ablated, and ablating living tissue in a single pulse.

In yet another aspect, the present invention relates to an apparatus for ablating living tissue. In one embodiment, the apparatus has a first laser for generating a first laser beam, a second laser for receiving and amplifying the first laser beam, and a spatial filter optically coupled to the first laser and the second laser for allowing selected fractions of the first laser beam to be received and amplified by the second laser so as to generate a second laser beam with sufficient strength in a single pulse for ablating living tissue. In one embodiment, the second laser beam generated has a maximum intensity higher than the maximum intensity of the laser beam generated by either the first laser or the second laser individually. The first laser and the second laser have same or different optical parameters. In one embodiment, the first laser and the second laser include a metal vapor laser, a Sr vapor laser, a Cu vapor laser, a free electron laser, an Er:YAG laser, a multiple Raman shifted Nd:YAG, an Alexandrite laser, or a tunable laser The apparatus also has an unstable resonator system to operate with the first laser to maximize the output of the first laser. In one embodiment, the unstable resonator system has a first mirror, a second mirror, and a third mirror optically positioned between the first mirror and the second mirror along an optical path.

The apparatus further has an expanding telescope positioned along an optical path between the first laser and the second laser, where the expanding telescope has a focal plane. The spatial filter is adjustable to allow the expanding telescope to selectively expand fractions of the incoming beam of light and outputting it as the outgoing beam of light.

Moreover, the apparatus has a timing control device arranged, in use, to communicate with the first laser and the second laser to synchronize them such that the second laser beam generated has sufficient strength and beam quality in a single pulse for ablating living tissue. In one embodiment, the timing control device controls the first laser and the second laser such that the second laser may function as an optical shutter to produce the second laser beam with an intensity that is above a threshold of intensity for single pulse ablation.

Additionally, the apparatus has means for focusing the second laser beam to a targeted region of a living subject for ablating living tissue.

In a further aspect, the present invention relates to a method of ablating living tissue. In one embodiment, the method includes the step of providing an apparatus having a first laser for generating a first laser beam, a second laser for receiving and amplifying the first laser beam, and a spatial filter optically coupled to the first laser and the second laser for allowing selected fractions of the first laser beam to be received and amplified by the second laser. In one embodiment, the first laser operates with a repetition rate in the range of from 1 kHz to 20 kHz and substantially around a wavelength that approximately corresponds to an energy absorption peak of at least one amide band of said living tissue, and the second laser operates with a repetition rate in the range of from 1 kHz to 20 kHz and substantially around a wavelength that approximately corresponds to an energy absorption peak of at least one amide band of said living tissue. In one embodiment, the first laser and the second laser include a metal vapor laser, a Sr vapor laser, a Cu vapor laser, a free electron laser, an Er:YAG laser, a multiple Raman shifted Nd:YAG, an Alexandrite laser, or a tunable laser.

The method further has the steps of operating the apparatus to output a second laser beam from the second laser, directing the second laser beam to a targeted region of a living subject at living tissue to be ablated, and ablating living tissue in a single pulse.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

FIG. 1 shows schematically a block diagram of a system for laser ablation according to one embodiment of the present invention.

FIG. 2 shows schematically a block diagram of a laser tube according to one embodiment of the present invention.

FIG. 3 shows a transverse power distribution in a first laser beam according to one embodiment of the present invention.

FIG. 4 shows a transverse power distribution in a second laser beam according to one embodiment of the present invention.

FIG. 5 shows a flowchart for ablating living tissue according to one embodiment of the present invention.

FIG. 6 shows a SEM image of a single pulse ablation of bone tissue according to one embodiment of the present invention, (a) a top view, and (b) a 45° perspective view.

FIG. 7 shows a SEM image of a single pulse ablation of bone tissue according to another embodiment of the present invention, (a) a top view, and (b) a 45° perspective view.

FIG. 8 shows an optical image of ablated spots of bone tissue according to one embodiment of the present invention, (a) and (b) for different target regions of the bone tissue.

FIG. 9 shows an optical image of ablated spots of bone tissue according to one embodiment of the present invention, (a) and (b) for different target regions of the bone tissue.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The description will be made as to the embodiments of the present invention in conjunction with the accompanying drawings 1-9. In accordance with the purposes of this invention, as embodied and broadly described herein, this invention, in one aspect, relates to an apparatus that utilizes a Sr vapor master oscillator-power amplifier (hereinafter “MOPA”) system to generate a laser beam with sufficient intensity and beam quality in a single pulse for ablating living tissue.

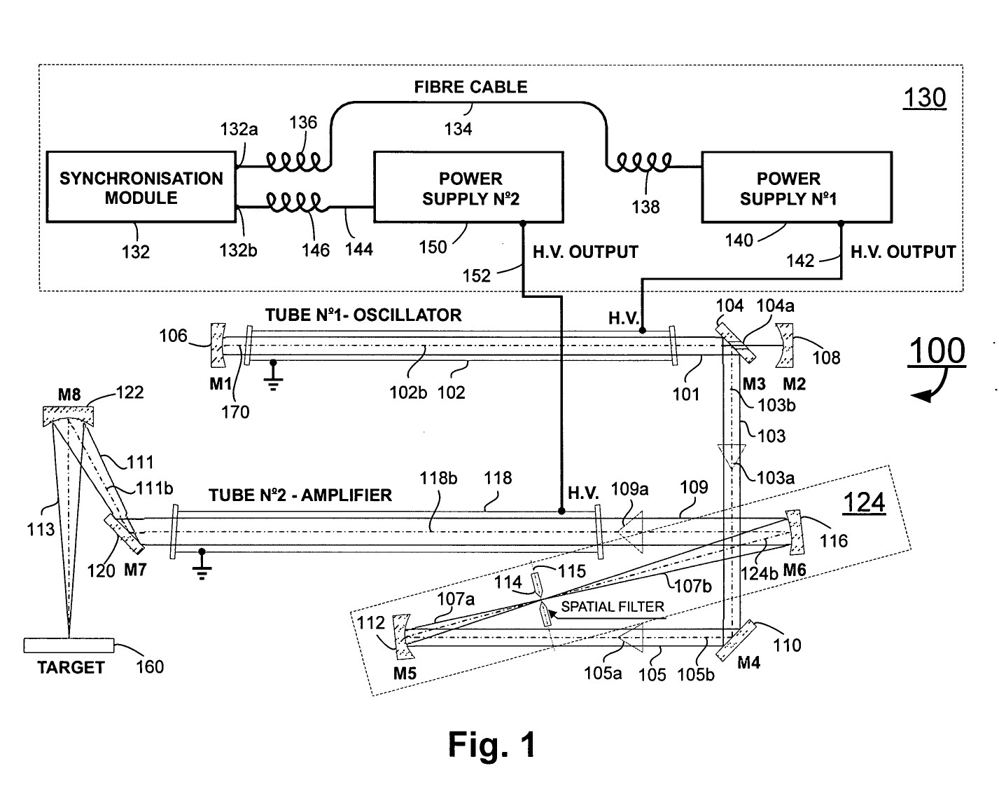

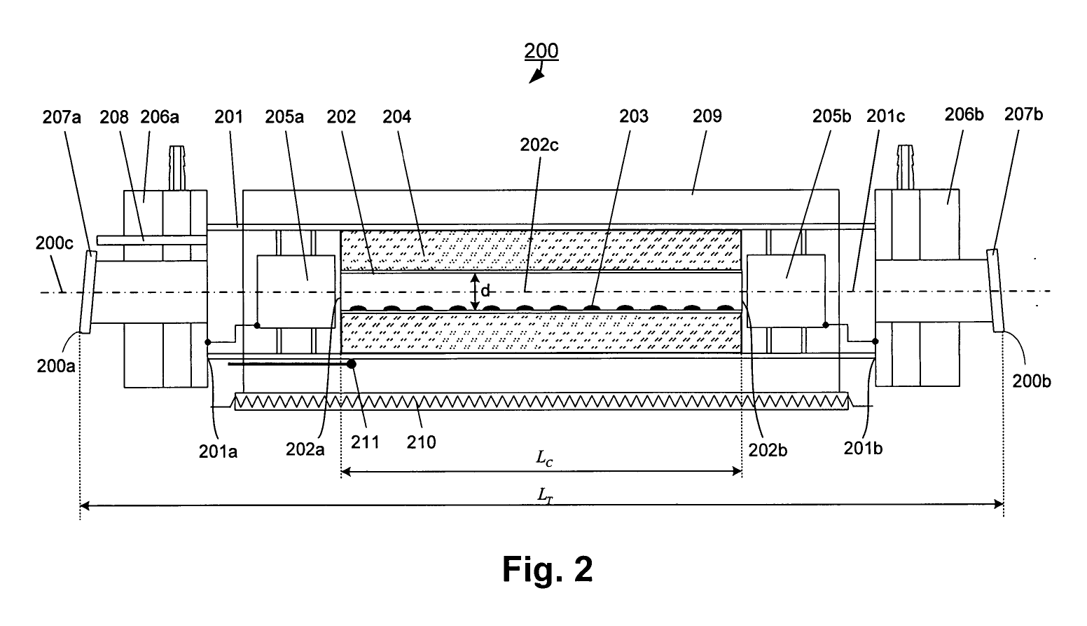

Referring in general to FIGS. 1-2, and in particular to FIG. 1 first, an apparatus 100 includes a first Sr vapor laser 102 for generating a first laser beam 103, a second Sr vapor laser 118 for receiving and amplifying the first laser beam 103, and a spatial filter 114 optically positioned between and coupled to the first Sr vapor laser 102 and the second Sr vapor laser 118 for allowing selected fractions of the first laser beam 103 to be received and amplified by the second Sr vapor laser 118 so as to generate a second laser beam 111 with sufficient strength and beam quality in a single pulse for ablating living tissue.

The apparatus 100 further includes an unstable resonator system operating with the first Sr vapor laser 102 for maximizing an output power of the first Sr vapor laser beam 103. In one embodiment, the unstable resonator system comprises a first concave mirror 106 having a focal length and a second concave mirror 108 having a focal length. The first concave mirror 106 and the second concave mirror 108 form a resonant cavity having an optical axis 170. The focal length of the first concave mirror 106 is same as or different from the focal length of the second concave mirror 108. In one embodiment, the focal length of the first concave mirror 106 is about 1700 mm, and the focal length of the second concave mirror 108 is about 120 mm. The first Sr vapor laser 102 is placed in the resonant cavity such that an optical axis 102b of the first Sr vapor laser 102 is substantially coincident with the optical axis 170 of the resonant cavity. The unstable resonator system also has a flat mirror 104 optically positioned between the first Sr laser tube 102 and the second concave mirror 108 on the optical axis 170 of the resonant cavity for outputting the first laser beam 103. In one embodiment, the flat mirror 104 includes a scraped hole 104a with a diameter of about 1.2 mm for allowing a laser beam 101 generated by the first Sr vapor laser partially to pass through and to be feedback from the second concave mirror 108. In one embodiment, the unstable resonator system has a magnification coefficient of about 14.

Each of the first Sr vapor laser 102 and the second Sr vapor laser 118 includes a corresponding laser tube. Referring now to FIG. 2, a laser tube 200 is shown according to one embodiment of the present invention. The laser tube 200 includes a quartz glass vacuum chamber 201 having an axis 201c, and a laser channel (discharge tube) 202 having an axis 202c and positioned inside the quartz glass vacuum chamber 201 such that the axis 202a of the laser channel 202 is substantially coincident with the axis 201a of the quartz glass vacuum chamber 201. The quartz glass vacuum chamber 201 also has a first end 201a and an opposite, second end 201b. The laser channel 202 is formed in a cylindrical tube having a diameter, d, a first end 202a and an opposite, second end 202b and a length, Lc, defined by the a first end 202a and the second end 202b, and is adapted for housing lasing sources 203 and serves as a gas discharge channel for lasing of the lasing sources 203 therein. The diameter d and the length L_{C} of the laser channel 202 together define an active lasing volume in the laser channel 202. The laser channel 202 is made of quartz glass or BeO ceramic, preferably, BeO ceramic. In one embodiment, the lasing sources 203 include about 30 pieces of Sr pellets equally spaced at intervals along the length Lc of the laser channel (discharge tube) 202 with each pellet about 0.5 grams. Other types of lasing sources can also be utilized to practice the current invention. Furthermore, the laser tube 200 includes a fiber insulation layer 204 placed therebetween the laser channel 202 and the quartz glass vacuum chamber 201.

The laser tube 200 also has a first electrode 205a and a second electrode 205b. In one embodiment, the first electrode 205a is positioned inside the quartz glass vacuum chamber 201 and proximate to the first end 202a of the laser channel 202, and the second electrode 205b is positioned inside the quartz glass vacuum chamber 201 and proximate to the second end 202b of the laser channel 202, electrode 205b. Both the first electrode 205a and the second electrode 205b are adapted for initializing gas discharges of the Sr pellets 203 inside the laser channel 202. In one embodiment, the first electrode 205a and the second electrode 205b include metallic Cu cylinders. In another embodiment, the first electrode 205a and the second electrode 205b include truncated tantalum cones.

Additionally, the laser tube 200 includes a thermal jacket 209 encasing the quartz glass vacuum chamber 201, an additional heating element 210 coupling with the thermal jacket 209 for heating the quartz glass vacuum chamber 201, and a thermocouple 211 placed therebetween the thermal jacket 209 and the quartz glass vacuum chamber 201 and proximate to the first end 202a of the laser channel 202 for controlling the temperature in the quartz glass vacuum chamber 201 and the laser channel 202. In one embodiment, the thermal jacket 209 is formed of a metallic material. Moreover, the laser tube 200 has a first water cooled vacuum flange 206a attached to the first end 201a of the quartz glass vacuum chamber 201, a second water cooled vacuum flange 206a attached to the second end 201b of the quartz glass vacuum chamber 201, and a vacuum source 208 coupled with the first water cooled vacuum flange 206a.

The laser tube 200 further has a first laser tube window 207a positioned proximate to the first water cooled vacuum flange 206a, and an opposite, second laser tube window 207b positioned proximate to the second water cooled vacuum flange 206b. In one embodiment, the first laser tube window 207a and the second laser tube window 207b include a material of calcium fluoride (CaF2) or barium fluoride (BaF2). The first laser tube window 207a and the second laser tube window 207b establish a first end 200a and a second end 200b of the laser tube 200, respectively. The first end 200a and the second end 200b of the laser tube 200 define a length, LT, of the laser tube 200. Additionally, the laser tube 200 has an axis 200c that is substantially coincident with the axis 202c of the laser channel 202 and the axis 201c of the quartz glass vacuum chamber 201.

Sr laser tube like the laser tube 200 can be utilized to practice the present invention. In one embodiment, a Sr laser tube, as shown in FIG. 2, includes a laser channel having a laser channel length, L_{C}=1000 mm, and a channel diameter, d=20 mm. The total length of the Sr laser tube in this embodiment is L_{T}=1500 mm. The Sr laser tube with these parameters may be referred as a first Sr laser tube in the description hereinafter or the convenience of readers. The Sr laser tube operates in the unstable resonator, as described above, with a discharge pulse frequency of about 4 kHz. When the laser tube operates with buffer gas He, a laser beam having a maximum power of about 3.2 W is output. This corresponds to about 0.8 mJ pulse energy for all lasing spectrum. The energy distribution of the laser pulse in this embodiment is about 70% of the total energy at wavelength about 6.45 μm, about 25% of the total energy at wavelength about 3 μm and about 5% of the total energy at wavelength about 1 μm, respectively. Relatively high portion of short wavelength fractions of the laser beam is because the laser tube operates with a low frequency and high voltage (14 KV), leading to more effective pumping of shorter wavelength fractions. In a cold condition, the laser tube has very high electrical impedance, thus it is preferable that the laser tube operates with a buffer gas mixture of about 50% He and of about 50% Ne. As a result, the laser tube produces laser energy that is 20% less than those with the buffer gas He, but operates more stably. In fixed regimes the laser tube generates very stable output power over a long period of time. For instance, instability of the Sr laser tube is in the range of about ±1% for three to four hours of operation.

In practice, the Sr laser tube operates in a self-heating mode for generate a Sr vapor laser beam. Output parameters of the Sr vapor laser vary with a repetition rate of the Sr vapor laser. The Sr vapor laser can be operated with a repetition rate between 1 kHz and 20 kHz. The higher the operated repetition rate (frequency), the hotter the Sr laser tube becomes and the greater the percentage of the output laser beam at wavelength about 6.45 μm is. When the Sr laser tube initially operates, roughly 70% of its output is at wavelength 6.45 μm. By increasing the operating temperature of the Sr laser tube via increasing the repetition rate this fraction of the 6.45 μm emission can be increased to over 90%. If the fraction of the 6.45 μm emission is higher than 90% in the total laser emission, the Sr laser tube may be overheated, leading to both instability and the loss of Sr vapor out of the Sr laser tube, which would in turn lead to a loss of efficiency and thus maximum output power. In one embodiment, the Sr vapor laser operates at 17 kHz, to maintain the proper tube temperature.

In another embodiment, a Sr laser tube has a geometrical dimension of a laser channel length, L_{C}=1500 mm, a channel diameter, d=33 mm, and a total laser tube length, L_{T}=2000 mm. The Sr laser tube with these parameters may be referred as a second Sr laser tube in the description hereinafter. The maximum laser power output from this laser tube is about 8 W when operating with the He gas and 6.5 W when operating with the Ne and He mixture, respectively. Therefore, the pulse energy of 2 mJ from a single laser tube can be realized theoretically. More practically, this laser tube can produce a laser beam having pulse energy about 1.5 mJ with average power about 6 W at a discharge pulse frequency of about 4 kHz.

To generate enough pulse energy and beam quality to achieve a single pulse ablation, a first Sr vapor laser and a second Sr vapor laser are utilized and configured in the form of a MOPA system, as shown in FIG. 1. The first Sr vapor laser and the second Sr vapor laser may have same or different optical parameters. In one embodiment, the first Sr laser tube is employed by the first Sr vapor laser and the second Sr laser tube is employed by the second Sr vapor laser, respectively. Each of the first Sr vapor laser and the second Sr vapor laser operates with a repetition rate in the range of from about 1 kHz to 20 kHz and substantially around a wavelength of 6.45 μm that approximately corresponds to an energy absorption peak of at least one amide band of living tissue.

Referring back to FIG. 1, the first Sr vapor laser 102 is adapted for generating a first laser beam 103 and the second Sr vapor laser 118 is adapted for receiving and amplifying the first laser beam 103 so as to generate a second laser beam 111 that has a maximum intensity higher than the maximum intensity of the laser beam generated by either the first Sr vapor laser 102 or the second Sr vapor laser 118 individually. In one embodiment, the maximum average power, about 9 W, corresponding to pulse energy of about 2.25 mJ, is obtained by operating the first Sr vapor laser 102 and the second Sr vapor laser 118 in the MOPA system.

A simple additive of full powers of the first Sr vapor laser 102 and the second Sr vapor laser 118 can generate a laser beam with sufficient intensity. However, the beam quality of the laser beam may not be good enough for effective ablation of living tissue in a single pulse. In one embodiment, as shown in FIG. 1, the beam quality of the laser beam 111 can be improved by filtering of the first laser beam 103 with a spatial filter 114 placed in a focal plane of a telescopic optical system, such as an expanding telescope 124. The spatial filter 114 is configured to selectively choose fractions of an incoming laser beam 117a and output it as an outgoing laser beam 107b to allow the expanding telescope 124 to selectively expand the chosen fractions of an incoming laser beam 105 and output it as an outgoing laser beam 109. In one embodiment, the spatial filter 114 has a diaphragm that is adjustable.

As shown in FIG. 1, the expanding telescope 124 is positioned between the first Sr vapor laser 102 and the second Sr vapor laser 118 along an optical path. The expanding telescope 124 has a focal plane 115 and an optical axis 240b. In one embodiment, the expanding telescope 124 includes a first concave mirror 112 having a focal length and a second concave mirror 116 having a focal length. The focal length of the first concave mirror 112 may be same as or different from the focal length of the second concave mirror 116. In one embodiment, the focal length of the first concave mirror 112 is about 500 mm, and the focal length of the second concave mirror 116 is about 1000 mm. The focal plane 115 is formed therebetween the first concave mirror 112 and the second concave mirror 116. In an alternative embodiment, the expanding telescope 124 includes a first optical lens, which receives an incoming laser beam, and a second complimentary optical lens, which outputs an outgoing laser beam corresponding to the incoming laser beam, such that the focal plane is formed therebetween (not shown). In one embodiment, the expanding telescope 124 has an expanding factor of about 2.

The laser beam 109 output from the expending telescope 124 is input into the second Sr laser 118, amplified therein and output as a second laser beam 111. The second laser beam 111 is then focused onto a target 160 of interest for tissue ablation by focusing means. In one embodiment, the focusing means includes a focusing mirror 122 having a focal length of about 300 mm. In another embodiment, the focusing means has a focusing lens (not shown).

A laser beam passing through the second Sr laser tube may be absorbed by the lasing sources in the second Sr laser tube. The laser beam absorption in the second Sr laser tube promises flexible control of the power of the second laser beam 111 output from the MOPA system. For the second Sr laser tube to function as an optical shutter, the time between electrical excitation of the first Sr vapor laser and electrical excitation of the second Sr vapor laser in the MOPA system needs to be specifically correlated. Fast switching between regimes of absorption and amplification can be achieved by changing a time delay generated in a timing control device. In one embodiment, as shown in FIG. 1, a timing control device 130 arranged, in use, to communicate with the first Sr vapor laser 102 and the second Sr vapor laser 118 to synchronize them such that the second laser beam 111 has sufficient strength and beam quality in a single pulse for ablating living tissue.

In one embodiment, the timing control device 130 has a synchronization module 132, a first power supply 140 with a high voltage output 142, and a second power supply 150 with a high voltage output 152. The synchronization module 132 has a first output 132a and a second output 132b. The first power supply 140 is electrically coupled to the first output 132a of the synchronization module 132 and to the first Sr vapor laser 102 through the high voltage output 142. In one embodiment, the electrically coupling between the first power supply 140 and the first output 132a of the synchronization module 132 may be implemented through electrical components such as inductors 136 and 138 and fibre cable 134 or the like. The second power supply 150 is electrically coupled to the second output 132b of the synchronization module 132 and to the second Sr vapor laser 118 through the high voltage output 142. The electrically coupling between the second power supply 150 and the second output 132b of the synchronization module 132, in one embodiment, may be implemented through electrical components such as an inductor 146 and cable 144 or the like. In one embodiment, the synchronization of the first Sr vapor laser 102 and the second Sr vapor laser 118 includes a time correlation between the first Sr vapor laser 102 and the second Sr vapor laser 118 such that the second Sr vapor laser 102 functions as an optical shutter so as to allow the amplifier laser tube 118 to output the second laser beam 111 having an intensity over a threshold for single pulse ablation at a specific time. In one embodiment, the threshold of intensity for single pulse ablation, in one embodiment, is about 2 J/cm².

In one embodiment, the Sr vapor MOPA system is set up on an optical table (Newport Inc., Irvine, Calif.). The output of the Sr vapor laser is directed onto an gold-coated off-axis parabolic mirror with a 25.4 mm focal length (Janos Technology, Townsend, Vt.), which focuses the Sr vapor laser onto a target of interest for tissue ablation.

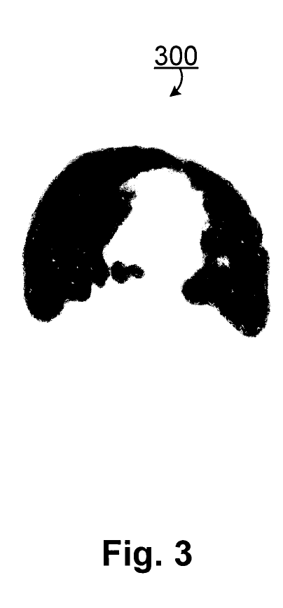

In operation, the synchronization module 132 generates a first signal and a second signal that is timely correlated with the first signal. The first signal causes the first power supply 140 to output a high voltage from the output 142 to the first Sr vapor laser 102 so as to generate a laser beam 101 in the unstable resonator. The laser beam 101 is then redirected out of the unstable resonator by the scraped mirror 104 to generate a first laser beam 103 in a direction 103a. The first laser beam 103 is received in the direction 103a and reflected as a beam 105 in a direction 105a by a flat mirror 110 placed on the junction of an optical path 103b of the first laser beam 103 and an optical path 105b of the reflected beam 105. The reflected beam 105 is then input into the expanding telescope 124 and reflected as a beam 107a along the optical path 124b of the expanding telescope 124 by the first concave mirror 112 of the expanding telescope 124, which is positioned on the junction of the optical path 105b of the reflected beam 105 and the optical path 124b of the expanding telescope 124. The reflected beam 107a is focused on the focal plane 115 of the expanding telescope 124 and fractionally selectively output as a beam 107b along the optical path 124b of the expanding telescope 124 by the spatial filter 114 placed on the focal plane 115 of the expanding telescope 124. The output beam 107b is then expanded and output as a beam 109 along a direction 109a by the second concave mirror 116 of the expanding telescope 124 which is positioned on the junction of an optical axis 118b of the second Sr vapor laser 118 and the optical path 124b of the expanding telescope 124. When the expanded beam 109 passes though the second Sr vapor laser 118, the second signal generated by the synchronization module 132 causes the second Sr vapor laser 118 to amplify the expanded beam 109 therein and output the second laser beam 111 from a flat mirror 120, which is positioned on the junction of the optical axis 118b of the second Sr vapor laser 118 and an optical path 111b of the second laser beam 111. The second laser beam 111 is received and then focused by a concave mirror 122 as a laser beam 113 on a target 160 of interest for tissue ablation Referring now to FIG. 3, a transverse power distribution 300 of a first Sr laser beam output from the unstable resonator, as shown in FIG. 1, is shown according to one embodiment of the present invention. In this embodiment, the first Sr laser beam is focused with a mirror having a 500 mm focal length and passed through a 500 μm pinhole. The first Sr laser beam has a complicated irregular structure containing diffraction limited fractions as well as fractions with higher divergence. As shown on FIG. 3, more than 60% of power of the first Sr laser beam has been transmitted through the pinhole with a divergence below 1 mrad. The rest of power (about 40%) of the first Sr laser beam has unacceptably high divergence and needs to be removed from next stages of operation of the system.

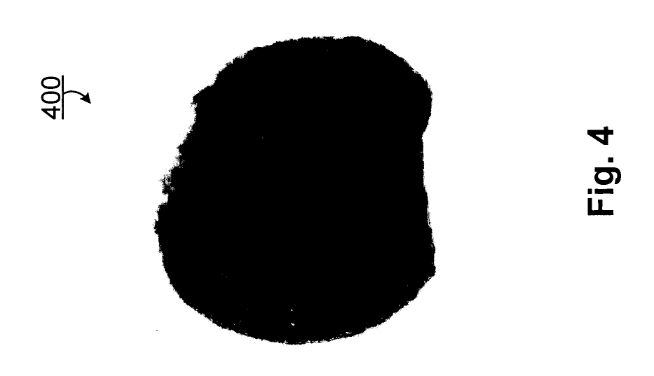

Referring to FIG. 4, a transverse power distribution 400 of a second Sr laser beam output from the MOPA system, as shown in FIG. 1, is shown according to one embodiment of the present invention. In this embodiment, the first Sr laser beam is filtered by a spatial filter in the focal plane of an expanding telescope, and expanded in a factor of 2 by the expanding telescope to produce an expanded beam. The expanded beam is amplified and output as the second Sr laser beam by the second Sr vapor laser. As shown in FIG. 4, observation of a final focal spot of the second Sr laser beam indicates that a significant part of power of the second Sr laser beam is concentrated in the near to diffraction limit of 0.2 mrad.

Other types of lasers can also be utilized as a first laser and a second laser to practice the present invention. The other types of lasers include a metal vapor laser, a Cu vapor laser, a free electron laser, an Er:YAG laser, a multiple Raman shifted Nd:YAG, an Alexandrite laser, or a tunable laser.

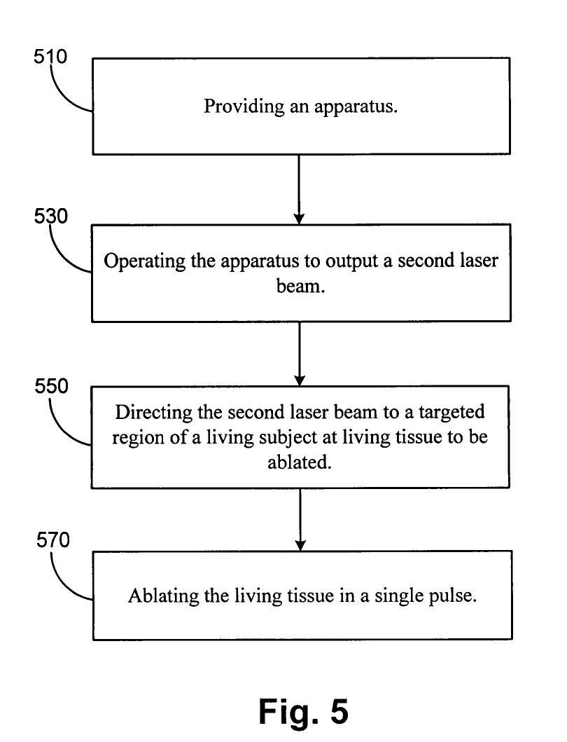

In another aspect, the present invention relates to a method of ablating living tissue. Referring to FIG. 5, the method includes the following steps: at step 510, an apparatus is provided. In one embodiment, the apparatus has a first laser for generating a first laser beam, a second laser for receiving and amplifying the first laser beam, and a spatial filter optically positioned between and coupled to the first laser and the second laser for allowing selected fractions of the first laser beam to be received and amplified by the second laser. The apparatus is configured in the form of a MOPA system. The first laser and the operates with a repetition rate in the range of from 1 kHz to 20 kHz and substantially around a wavelength of 6.45 μm that approximately corresponds to an energy absorption peak of at least one amide band of said living tissue. In one embodiment, the first laser and the second laser include a metal vapor laser, a Sr vapor laser, a Cu vapor laser, a free electron laser, an Er:YAG laser, a multiple Raman shifted Nd:YAG, an Alexandrite laser, or a tunable laser.

At step 530, the apparatus is operated to output a second laser beam from the second laser. The operation is implemented by a timing control device as described above. At step 550, the second laser beam is directed to a targeted region of a living subject at living tissue to be ablated. The directing step is performed with focus means, such as an optical focus lens, a concave mirror. And at step 570, the living tissue is ablated in a single pulse.

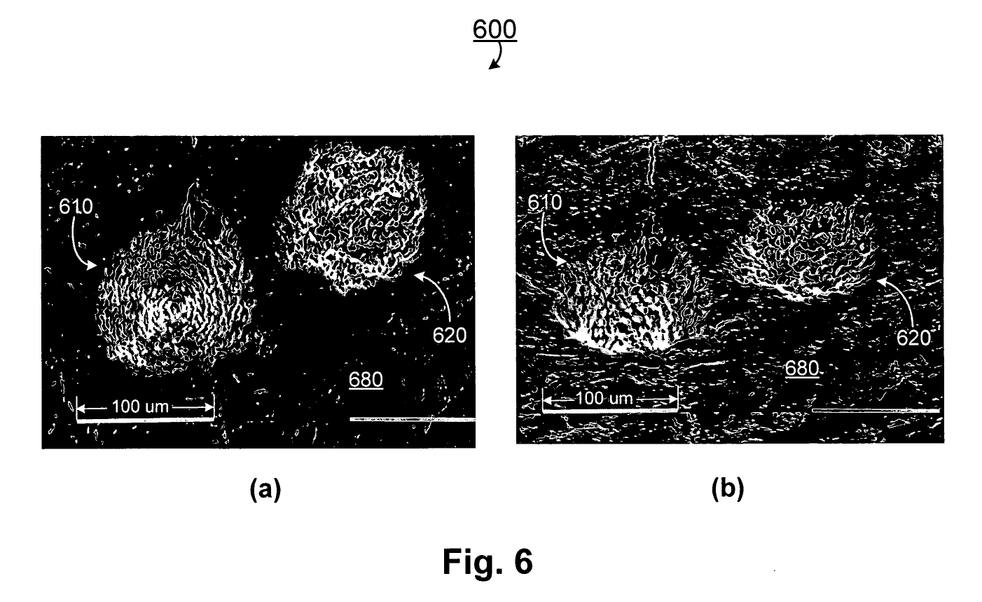

Referring now to FIG. 6, a scanning electron microscope (hereinafter “SEM”) image 600 of a single pulse ablation on bone tissue 680 is shown according to one embodiment of the present invention, where ablated spots 610 and 620 of the bone tissue 680 are corresponding to SEM images of two target regions of the single pulse ablation, respectively. As shown in FIG. 6, the sizes of the ablated spots 610 and 620 of the bone tissue 680 are about 100 μm, which corresponds to the size of the Sr vapor laser beam for the tissue ablation. In this embodiment, the Sr vapor laser beam for the single pulse ablation operates at a repetition rate of about 20 Hz, and pulse energy of about 1.2 mJ. The laser beam is focused onto the target region of the bone tissue 680 by a CaF₂ lens having a focal length of about 500 mm. As shown in FIG. 6, the considerable amount of the bone tissue 680 is removed by the single pulse ablation. It is observed, with a very rough estimation from the 45° view SEM image, as shown in FIG. 6b, that the ablated depths of the ablated spots 610 and 620 are in a range of about 15-30 μm for the single pulse ablation with the pulse energy of about 1.2 mJ.

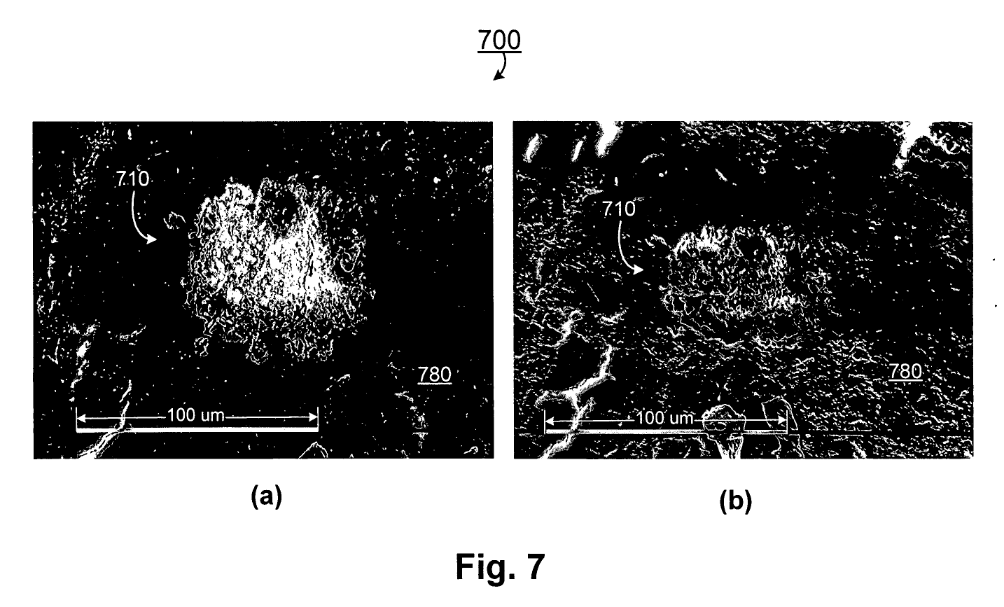

Referring to FIG. 7, a SEM image 700 of a single pulse ablation on bone tissue 780 includes an ablated spot 710 of the bone tissue 780. As shown in FIG. 7, the size of the ablated spot 710 of the bone tissue 780 is about 70 μm. In this embodiment, the Sr vapor laser beam for the single pulse ablation operates at a repetition rate of about 4 kHz with pulse energy of about 0.5 mJ. The Sr vapor laser beam has a size of about 70 μm and is focused on the bone tissue 780 by a gold concave mirror having a focal length of about 300 mm. The result shown in FIG. 7 indicates that even with relatively low pulse energy, the Sr vapor laser beam can be used to conduct effective tissue ablation due to really good beam quality. An estimation for the ablated spot 710 shown in FIG. 2 indicates that the ablation depth for the tissue ablation with the pulse energy of about 0.5 mJ is in a range of about 10-25 μm.

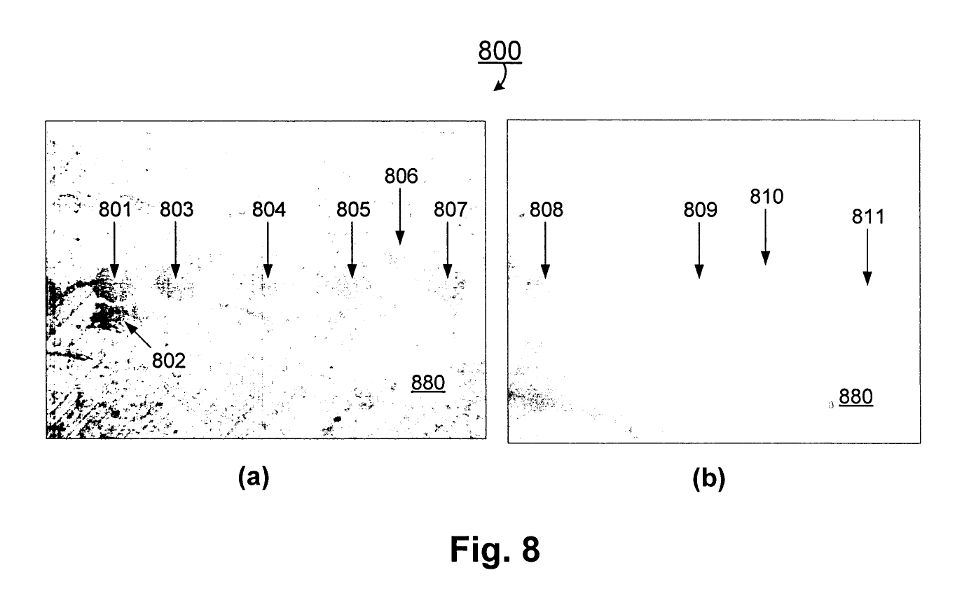

FIG. 8 shows an optical image 800 of the ablated spots 801-811 resulted from the single pulse ablation on bone tissue 880 with a Sr vapor laser. In this exemplary embodiment, the Sr vapor laser operates at a repetition rate of about 20 Hz with pulse energy of about 1.2 mJ and is focused onto the target region of the bone tissue 880 by a CaF₂ lens having a focal length of about 500 mm. The optical image 800 is magnified about 100 times of an actual size of the bone tissue 880. As shown in FIG. 8, borders between the ablated tissue, inside the ablated spots 801-811, and the non-ablated tissue, outside the ablated spots 801-811, are barely observed. Lack of changes on the borders between the ablated tissue and the non-ablated tissue is indirect evidence of minimal thermal damage of surrounding tissue using the Sr vapor MOPA laser system as described above.

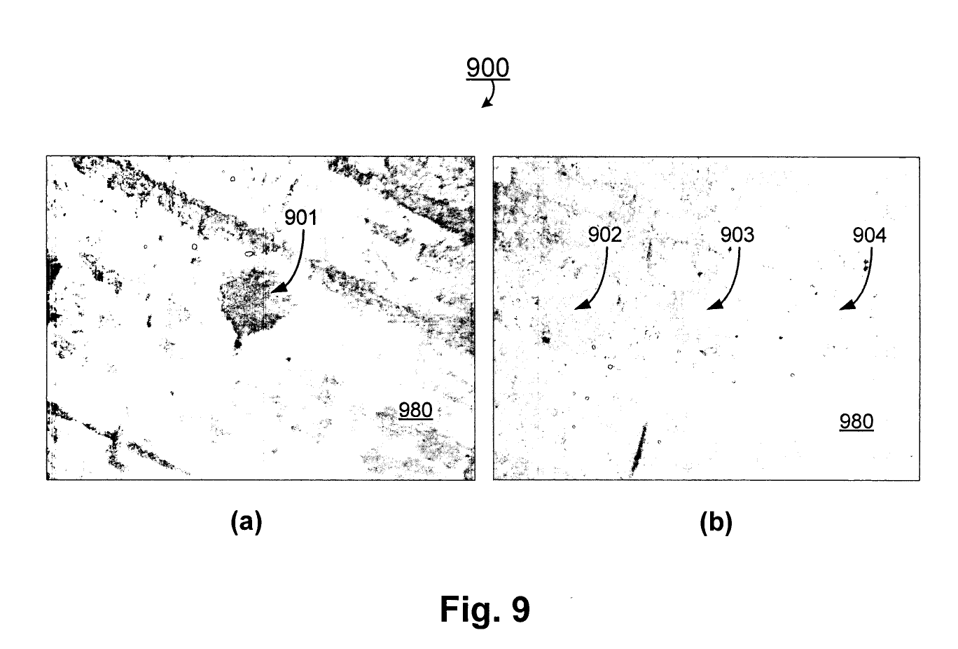

FIG. 9 shows an optical image 900 of the ablated spots 901-904 resulted from the single pulse ablation on bone tissue 980 with a Sr vapor laser operating at a repetition rate of about 4 kHz with pulse energy of about 0.5 mJ. The Sr vapor laser beam has a size of about 70 μm and is focused on the bone tissue 980 by a gold concave mirror having a focal length of about 300 mm. The magnification of the optical image 900 is about 200 times of an actual size of the bone tissue 980. As shown in FIG. 9, borders between the ablated tissue, inside the ablated spots 901-904, and the non-ablated tissue, outside the ablated spots 901-904, are barely identified, indicating minimal thermal damage of surrounding tissue using the Sr vapor MOPA laser system as described above.

For efficiently performing a single pulse ablation of living tissue, a mirror scanning system for automatic control of a laser beam scanning speed and desired pattern formation may be incorporated with the Sr vapor MOPA laser system. This is especially important in the following cases. First when hard tissue has to be cut only automatic scanning system can be apply due to the requirement for exact overlapping of consecutive scans. Second, the Sr vapor laser operates at a high repetition rate, which requires high scanning speed in order to avoid heat from building up. Necessity of high throughput by using high repetition rate may require a computer to control the laser beam scanning system. For applications where manual control of laser ablated pattern and few pulses delivery like optic nerve sheath fenestration are needed, IR transmitted or hollow waveguides can be used.

In the present invention, thus, among other unique feeatures, an apparatus of utilizing the MOPA laser system to generate a laser beam with sufficient strength and beam quality in a single pulse for ablating living tissue is disclosed.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### LIST OF REFERENCES

[1]. G. Edwards, R. Logan, M. Copeland, L. Reinisch, J. Davidson, B. Johnson, R. Maciunas, M. Mendenhall, R. Ossoff, J. Tribble, J. Werkhaven, and D. Oday, “Tissue Ablation By a Free-Electron Laser Tuned to the Amide-II Band,” Nature, vol. 371, pp. 416-419, 1994.
[2] J. H. Shen, V. A. Casagrande, K. M. Joos, D. J. Shetlar, R. R. D., W. S. Head, J. A. Mavity-Hudson, and A. H. Nunnally, “Acute optic nerve sheath fenestration with the free-electron laser,” in: Ophthalmic Technologies IX, P. O. Rol, K. M. Joos, F. Manns (eds), SPIE, Bellingham, vol. 3591, pp. 235-240, 1999.
[3] K. M. Joos, G. S. Edwards, J. H. Shen, R. Shetlar, R. Robinson, and D. O'Day, “Free Electron Laser (FEL) laser-tissue interaction with human cornea and optic nerve,” in: Ophthalmic Technologies VI, J-M Parel, K. M. Joos, P. O. Rol (eds), SPIE, Bellingham, vol. 2673, pp. 89-92, 1996.
[4] D. Shetlar, K. Joos, J. H. Shen, and R. Robinson, “Endoscopic goniotomy with the free electron laser,” Invest Ophtalmol Vis Sci (Suppl), vol. 38, pp. 169, 1997.
[5] K. M. Joos, J. H. Shen, D. J. Shetlar, and V. A. Casagrande, “Optic nerve sheath fenestration with a novel wavelength produced by the free electron laser (FEL),” Lasers Surg Med, vol. 27, pp. 191-205, 2000.
[6] K. M. Joos, L. Mawn, J. H. Shen, E. D. Jansen, and V. A. Casagrande, “Acute optic nerve sheath fenestration in humans using the free electron laser (FEL): a case report,” in: Ophthalmic Technologies XII, F. Manns, P. Soderberg and A. Ho (eds), SPIE, Bellingham, Wash., vol. 4611, pp. (in press), 2002.
[7] M. L. Copeland, G. Cram, W. Gabella, E. D. Jansen, J. D. Mongin, H. S. Pratisto, S. R. Uhlhorn, and G. S. Edwards, “First human application of a free electron laser,” International Free Electron Laser Conference Users Workshop, 2000.
[8] M. Copeland, G. P. Cram, G. S. Edwards, D. Ernst, W. Gabella, and E. D. Jansen, “First Human Surgery with a Free Electron Laser,” SPIE, Plenary Session, 2000.
[9] G. S. Edwards, R. H. Austin, F. E. Carroll, M. L. Copeland, M. E. Couprie, W. E. Gabella, R. F. Haglund, B. A. Hooper, M. S. Hutson, E. D. Jansen, e. al., “Free electron laser based biophyscal and biomedical instrumentation,” Review of Scientific Instrumentation, vol. 74, pp. 3207-3245, 2003.

1. An apparatus for ablating living tissue, comprising:
a. a first Sr vapor laser for generating a first laser beam;
b. a second Sr vapor laser for receiving and amplifying the first laser beam; and
c. a spatial filter optically positioned between and coupled to the first Sr vapor laser and the second Sr vapor laser for allowing selected fractions of the first laser beam to be received and amplified by the second Sr vapor laser so as to generate a second laser beam with sufficient strength in a single pulse for ablating living tissue.

2. The apparatus of claim 1, further comprising an expanding telescope positioned along an optical path between the first Sr vapor laser and the second Sr vapor laser, wherein the expanding telescope has a focal plane.

3. The apparatus of claim 2, wherein the spatial filter is adjustable to allow the expanding telescope to selectively expand fractions of the incoming beam of light and outputting it as the outgoing beam of light.

4. The apparatus of claim 3, wherein the expanding telescope comprises a first optical lens, which receives an incoming beam of light, and a second complimentary optical lens, which outputs an outgoing beam of light corresponding to the incoming beam of light, such that the focal plane is formed therebetween.

5. The apparatus of claim 3, wherein the expanding telescope comprises a first concave mirror having a focal length, which receives an incoming beam of light, and a second concave mirror having a focal length, which outputs an outgoing beam of light corresponding to the incoming beam of light, such that the focal plane is formed therebetween.

6. The apparatus of claim 1, further comprising a timing control device arranged, in use, to communicate with the first Sr vapor laser and the second Sr vapor laser to synchronize them such that the second laser beam generated has sufficient strength and beam quality in a single pulse for ablating living tissue.

7. The apparatus of claim 6, wherein the timing control device controls the first Sr vapor laser and the second Sr vapor laser such that the second Sr vapor laser may function as an optical shutter to produce the second laser beam with an intensity that is above a threshold of intensity for single pulse ablation.

8. The apparatus of claim 7, wherein the threshold of intensity for single pulse ablation is about 2 J/cm².

9. The apparatus of claim 7, wherein the timing control device comprises:
a. a synchronization module having a first output and a second output;
b. a first power supply with a high voltage output; and
c. a second power supply with a high voltage output,
wherein the first power supply is electrically coupled to the first output of the synchronization module and to the first Sr vapor laser through the high voltage output, and the second power supply is electrically coupled to the second output of the synchronization module and to the second Sr vapor laser through the high voltage output, respectively.

10. The apparatus of claim 6, wherein the second laser beam generated has a maximum intensity higher than the maximum intensity of the laser beam generated by either the first Sr vapor laser or the second Sr vapor laser individually.

11. The apparatus of claim 1, further comprising an unstable resonator system to operate with the first Sr vapor laser to maximize the output of the first Sr vapor laser.

12. The apparatus of claim 11, wherein the unstable resonator system comprises:
a. a first mirror;
b. a second mirror; and
c. a third mirror optically positioned between the first mirror and the second mirror along an optical path.

13. The apparatus of claim 12, wherein the first mirror comprises a concave mirror having a focal length, the second mirror comprises a concave mirror having a focal length, and the third mirror comprises a scraped mirror for outputting the first laser beam.

14. The apparatus of claim 1, further comprising means for focusing the second laser beam to a targeted region of a living subject for ablating living tissue.

15. The apparatus of claim 1, wherein the first Sr vapor laser operates with a repetition rate in the range of from 1 kHz to 20 kHz and substantially around a wavelength of 6.45 μm that approximately corresponds to an energy absorption peak of at least one amide band of said living tissue.

16. The apparatus of claim 15, wherein the second Sr vapor laser operates with a repetition rate in the range of from 1 kHz to 20 kHz and substantially around a wavelength of 6.45 μm that approximately corresponds to an energy absorption peak of at least one amide band of said living tissue.

17. The apparatus of claim 16, wherein the second Sr vapor laser and the first Sr vapor laser have same or different optical parameters.

18. The apparatus of claim 1, wherein the apparatus is adapted for tabletop operations.

19. A method of ablating living tissue, comprising the step of:
a. providing an apparatus having:
(i). a first Sr vapor laser for generating a first laser beam;
(ii). a second Sr vapor laser for receiving and amplifying the first laser beam; and
(iii). a spatial filter optically positioned between and coupled to the first Sr vapor laser and the second Sr vapor laser for allowing selected fractions of the first laser beam to be received and amplified by the second Sr vapor laser;
b. operating the apparatus to output a second laser beam from the second Sr vapor laser;
c. directing the second laser beam to a targeted region of a living subject at living tissue to be ablated; and
d. ablating the living tissue in a single pulse.

20. The method of claim 19, wherein the first Sr vapor laser operates with a repetition rate in the range of from 1 kHz to 20 kHz and substantially around a wavelength of 6.45 μm that approximately corresponds to an energy absorption peak of at least one amide band of said living tissue.

21. The method of claim 20, wherein the second Sr vapor laser operates with a repetition rate in the range of from 1 kHz to 20 kHz and substantially around a wavelength of 6.45 μm that approximately corresponds to an energy absorption peak of at least one amide band of said living tissue.

22. The method of claim 21, wherein the second Sr vapor laser and the first Sr vapor laser have same or different optical parameters.

23. An apparatus for ablating living tissue, comprising:
a. a first laser for generating a first laser beam;
b. a second laser for receiving and amplifying the first laser beam; and
c. a spatial filter optically coupled to the first laser and the second laser for allowing selected fractions of the first laser beam to be received and amplified by the second laser so as to generate a second laser beam with sufficient strength in a single pulse for ablating living tissue.

24. The apparatus of claim 23, further comprising an expanding telescope positioned along an optical path between the first laser and the second laser, wherein the expanding telescope has a focal plane.

25. The apparatus of claim 24, wherein the spatial filter is adjustable to allow the expanding telescope to selectively expand fractions of the incoming beam of light and outputting it as the outgoing beam of light.

26. The apparatus of claim 25, wherein the expanding telescope comprises a first optical lens, which receives an incoming beam of light, and a second complimentary optical lens, which outputs an outgoing beam of light corresponding to the incoming beam of light, such that the focal plane is formed therebetween.

27. The apparatus of claim 25, wherein the expanding telescope comprises a first concave mirror having a focal length, which receives an incoming beam of light, and a second concave mirror having a focal length, which outputs an outgoing beam of light corresponding to the incoming beam of light, such that the focal plane is formed therebetween.

28. The apparatus of claim 23, further comprising a timing control device arranged, in use, to communicate with the first laser and the second laser to synchronize them such that the second laser beam generated has sufficient strength and beam quality in a single pulse for ablating living tissue.

29. The apparatus of claim 28, wherein the timing control device controls the first laser and the second laser such that the second laser may function as an optical shutter to produce the second laser beam with an intensity that is above a threshold of intensity for single pulse ablation.

30. The apparatus of claim 28, wherein the timing control device comprises:
a. a synchronization module having a first output and a second output;
b. a first power supply with a high voltage output; and
c. a second power supply with a high voltage output,
wherein the first power supply is electrically coupled to the first output of the synchronization module and to the first laser through the high voltage output, and the second power supply is electrically coupled to the second output of the synchronization module and to the second laser through the high voltage output, respectively.

31. The apparatus of claim 28, wherein the second laser beam generated has a maximum intensity higher than the maximum intensity of the laser beam generated by either the first laser or the second laser individually.

32. The apparatus of claim 23, further comprising an unstable resonator system to operate with the first laser to maximize the output of the first laser.

33. The apparatus of claim 32, wherein the unstable resonator system comprises:
a. a first mirror;
b. a second mirror; and
c. a third mirror optically positioned between the first mirror and the second mirror along an optical path.

34. The apparatus of claim 33, wherein the first mirror comprises a concave mirror having a focal length, the second mirror comprises a concave mirror having a focal length, and the third mirror comprises a scraped mirror for outputting the first laser beam.

35. The apparatus of claim 23, further comprising means for focusing the second laser beam to a targeted region of a living subject for ablating living tissue.

36. The apparatus of claim 23, wherein the second laser and the first laser have same or different optical parameters.

37. The apparatus of claim 36, wherein the first laser comprises a metal vapor laser, a Sr vapor laser, a Cu vapor laser, a free electron laser, an Er:YAG laser, a multiple Raman shifted Nd:YAG, an Alexandrite laser, or a tunable laser.

38. The apparatus of claim 36, wherein the second laser comprises a metal vapor laser, a Sr vapor laser, a Cu vapor laser, a free electron laser, an Er:YAG laser, a multiple Raman shifted Nd:YAG, an Alexandrite laser, or a tunable laser.

39. The apparatus of claim 23, wherein the apparatus is adapted for tabletop operations.

40. A method of ablating living tissue, comprising the step of:
a. providing an apparatus having:
(i). a first laser for generating a first laser beam;
(ii). a second laser for receiving and amplifying the first laser beam; and
(iii). a spatial filter optically coupled to the first laser and the second laser for allowing selected fractions of the first laser beam to be received and amplified by the second laser;
b. operating the apparatus to output a second laser beam from the second laser;
c. directing the second laser beam to a targeted region of a living subject at living tissue to be ablated; and
d. ablating the living tissue in a single pulse.

41. The method of claim 40, wherein the first laser operates with a repetition rate in the range of from 1 kHz to 20 kHz and substantially around a wavelength that approximately corresponds to an energy absorption peak of at least one amide band of said living tissue.

42. The method of claim 41, wherein the second laser operates with a repetition rate in the range of from 1 kHz to 20 kHz and substantially around a wavelength that approximately corresponds to an energy absorption peak of at least one amide band of said living tissue.

43. The method of claim 42, wherein the second laser and the first laser have same or different optical parameters.

44. The method of claim 43, wherein the first laser comprises a metal vapor laser, a Sr vapor laser, a Cu vapor laser, a free electron laser, an Er:YAG laser, a multiple Raman shifted Nd:YAG, an Alexandrite laser, or a tunable laser.

45. The method of claim 43, wherein the second laser comprises a metal vapor laser, a Sr vapor laser, a Cu vapor laser, a free electron laser, an Er:YAG laser, a multiple Raman shifted Nd:YAG, an Alexandrite laser, or a tunable laser.
